(19) United States
(12) Patent Application Publication
(10) Pub. No.: US 2026/0349836 A1
(43) Pub. Date: Nov. 5, 2026

(54) WORKLOAD MANAGEMENT METHOD

(71) Applicant: Lenovo Enterprise Solutions (Singapore) Pte. Ltd., Singapore (SG)

(72) Inventors: Fred Allison Bower, III, Durham, NC (US); Caihong Zhang, Shanghai (CN)

(21) Appl. No.: 19/116,434

(22) PCT Filed: Jul. 21, 2023
(86) PCT No.: PCT/CN2023/108527

§ 371 Date: Mar. 28, 2025

(51) Int. Cl. G06F 9/50

(52) U.S. Cl. CPC G06F 9/5088; G06F 9/5044; G06F 9/505; G06F 2209/503

(57) ABSTRACT

A workload management method includes selecting a first compute node and a first target node from a resource pool for composition; determining the first compute node state; assigning available resources from the first target node to the first compute node to compose the first compute node in response to the first compute node being in a composable state based on node composition information; and storing the node composition information in a configuration manager in response to the first compute node being in a non-composable state.

### FIELD OF TECHNOLOGY

The present disclosure relates to the field of computing technology and, more specifically, to a workload management method.

### BACKGROUND

With the physical constraints of the architecture of a computing system in conventional technology, a certain amount of computing power is wasted or underutilized due to the fluctuation of workloads of the computing system. In order to improve the flexibility and efficiency of the computing systems, a software-defined, composable disaggregated infrastructure (CDI) has been proposed. In a CDI, computing resources such as processors, storage devices, and networking resources can be shared and interconnected on demand using a configuration manager to compose a compute node to handle specific workloads. When the specific workloads are completed, the resources of the compute node can be released back to a resource pool for use by another compute node.

In conventional technology, before the operating system of a compute node is booted and the compute node is ready for composing, the composition of the compute node cannot be realized as the configuration manager is not aware of the availability of the compute nodes in the resource pool. As such, the efficiency in composing a compute node is affected due to the delay on the availability of the computing nodes.

### BRIEF SUMMARY OF THE DISCLOSURE

An aspect of the present disclosure provides a workload management method. The workload management method includes selecting a first compute node and a first target node from a resource pool for composition; determining the first compute node state; assigning available resources from the first target node to the first compute node to compose the first compute node in response to the first compute node being in a composable state based on node composition information; and storing the node composition information in a configuration manager in response to the first compute node being in a non-composable state.

Another aspect of the present disclosure provides a workload management apparatus. The workload management apparatus a processor; and a memory storing one or more sets of instruction sets that, when executed by the processor, causes to the processor to select a first compute node and a first target node from a resource pool for composition; determine the first compute node state; assign available resources from the first target node to the first compute node to compose the first compute node in response to the first compute node being in a composable state based on node composition information; and store the node composition information in a configuration manager in response to the first compute node being in a non-composable state.

Another aspect of the present disclosure provides a computing system. The computing system includes a resource pool including a plurality of compute nodes and target nodes; and a configuration manager configured to compose a first compute node by selecting the first compute node and a first target node from the resource pool; determining the first compute node state; assigning available resources from the first target node to the first compute node to compose the first compute node in response to the first compute node being in a composable state based on node composition information; and storing the node composition information in response to the first compute node being in a non-composable state.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 is a diagram of a software-defined, composable disaggregated infrastructure (CDI) according to an embodiment of the present disclosure;

FIG. 2 is a flowchart of a workload management method according to an embodiment of the present disclosure;

FIG. 3 is a flowchart of another workload management method according to an embodiment of the present disclosure;

FIG. 4 is a structural diagram of a workload management apparatus according to an embodiment of the present disclosure.

### DETAILED DESCRIPTION

The technical solutions provided by the present disclosure according to various embodiments are described below with reference to the drawings. The described embodiments are only part of the embodiments of the present disclosure. Other embodiments acquired by a person of ordinary skill in the art based on the described embodiments without departing from the spirit of the disclosure are the within scope of the present disclosure. It should be understood that such description is illustrative only but is not intended to limit the scope of the present disclosure. In addition, in the following description, known structures and technologies are not described to avoid unnecessary obscuring of the present disclosure.

The terms used herein is for the purpose of describing particular embodiments only, but is not intended to limit the present disclosure. The terms such as “comprising”, “including”, “containing” and the like as used herein indicate the presence of the features, steps, operations and/or components, but do not preclude the presence or addition of one or more other features, steps, operations or components.

All terms (including technical and scientific terms) used herein have the same meanings as commonly understood by the skilled in the art, unless defined otherwise. It should be noted that the terms used herein should be construed to have the same meanings as the context of the present disclosure and should not be interpreted in an idealized or overly stereotyped manner.

In terms of a statement such as “at least one of A, B, and C, etc. ,” it should be generally interpreted in light of the ordinary understanding of the expression by those skilled in the art. For example, “a system including at least one of A, B, and C” shall include, but is not limited to, a system including A alone, a system including B alone, a system including C alone, a system including A and B, a system including A and C, a system including B and C, and/or a system including A, B, and C, etc. In terms of a statement similar to “at least one of A, B or C, etc.”, it should generally be interpreted in light of the ordinary understanding of the expression by those skilled in the art. For example, “a system including at least one of A, B or C” shall include, but is not limited to, a system including A alone, a system including B alone, a system including C alone, a system including A and B, a system including A and C, a system including B and C, and/or a system including A, B, and C, etc.

A few block diagrams and/or flowcharts are shown in the accompanying drawings. It should be understood that some of the blocks or combinations thereof in the block diagrams and/or flowcharts may be implemented by computer executable instructions. The computer executable instructions may be provided to a general purpose computer, a dedicated computer, or processors of other programmable data processing apparatus, so that the instructions, when being executed by the processor, may create means for implementing the functions/operations as described in the block diagrams and/or flowcharts.

Thus, the techniques of the present disclosure may be implemented in forms of hardware and/or software (including firmware, microcode, etc.). In addition, the techniques of the present disclosure may be embodied in a form of computer program instructions stored in a computer readable medium. The computer program instructions may be used by an instruction execution system or in conjunction with an instruction execution system. In the context of the present disclosure, the computer readable medium may be any medium capable of containing, storing, transmitting, propagating, or transmitting instructions. For example, the computer readable media may include, but are not limited to, electrical, magnetic, optical, electromagnetic, infrared or semiconductor systems, apparatuses, devices, or propagation media. Particular examples of the computer readable media may include a magnetic storage device, such as a magnetic tape or a hard drive disk (HDD); an optical storage device, such as an optical disk (CD-ROM); a memory, such as a random access memory (RAM) or a flash memory; and/or a wired/wireless communication link.

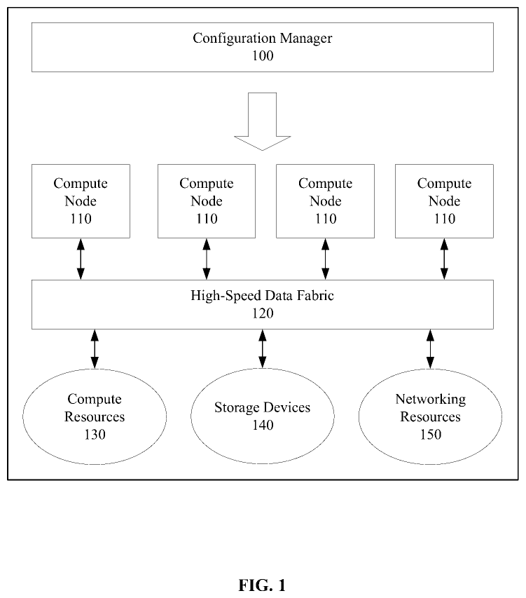

FIG. 1 is a diagram of a software-defined, composable disaggregated infrastructure (CDI) according to an embodiment of the present disclosure.

As shown in FIG. 1, a CDI includes a configuration manager 100, a plurality of compute nodes 110, a high-speed data fabric 120, compute resources 130, storage devices 140, and networking resources 150. The configuration manager 100 is connected to the compute nodes 110 such that a composition request can be sent from the configuration manager 100 to one or more of the compute nodes 110. After receiving the composition request, shared resources such as the compute resources 130, storage devices 140, and networking resources 150 can be connected to one or more compute nodes 110 through the high-speed data fabric 120 based on the composition request to compose the one or more compute nodes 110. As such, the one or more compute nodes 110 can be compose on demand to handle specific workloads. When the specific workloads are completed, the shared resources of the compute nodes can be released back to a resource pool for use by another compute node.

In some embodiments, the computing systems 110 may include, but are not limit to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the high-speed data fabric 120 may be a 100 GB Ethernet, an infiniband, or an optical interconnect to provide data links between the shared resources and the computing nodes 110. As such, the compute nodes 110 can be composed from the available resources in a resource pool.

It should be noted that the compute resources 130, storage devices 140, and networking resources 150 are examples of the shared resources. In some embodiments, the shared resources may further include, non-volatile memories, hard disk (HDD) storages, and field programmable gate arrays (FPGA).

As described above, in conventional technology, before the operating system of a compute node is booted and the compute node is ready for composing, the composition of a computing node cannot be realized as the configuration manager is not aware of the available compute nodes in the resource pool.

An embodiment of the present disclosure provide a workload management method in which the state of a compute node can be constantly monitored and a composition request can be submitted to the compute node through a configuration manger before the compute node in the resource pool is available to begin composing. As such, the efficiency in composing the compute node can be improved by reducing the delay in waiting on the availability of the computing node before submitting the composition request.

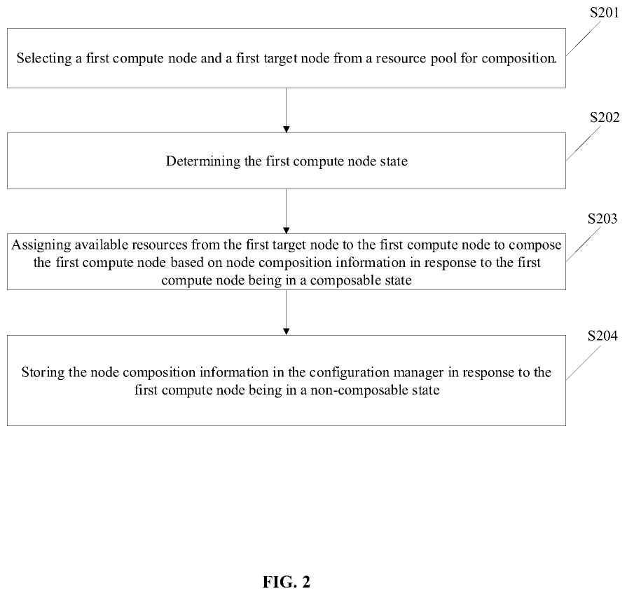

FIG. 2 is a flowchart of a workload management method according to an embodiment of the present disclosure. The workload management method will be described in detail below.

S201, selecting a first compute node and a first target node from a resource pool for composition.

The resource pool may include a plurality of compute nodes, and the configuration manger can select a first compute node for composition based on the composition request. Subsequently, available resources at the first target node may be assigned to the first compute node to complete specific workloads. For example, if a specific workload needs 2 storage devices and 3 networking resources to complete, the configuration manager can issue a composition request including this need to the first compute node that can handle the specific workload, identify the first target node having 2 storage devices and 3 networking resources to share, and assign the 2 storage devices and 3 networking resources to the first compute node to complete the specific workload.

S202, determining the first compute node state.

In some embodiments, the state of the first compute node may be determined by the configuration manager actively querying the state of the first compute node. For example, when a compute node is selected as the first compute node, the configuration manager may send a query to the first compute node to check on the state of the first compute node. In response to receiving the query from the configuration manager, the first compute node may report the operating state of the first compute node to the configuration manager.

In some embodiments, the state of the first compute node may be determined by the first compute node actively reporting its state to the configuration manager in response to satisfying a condition. The condition may include, but is not limited to, when the workloads currently assigned to the first compute node are completed, or when a set portion of the workloads currently assigned to the first compute node are completed. For example, the first compute node may report its operating state to the configuration manager when 90% of the currently assigned workloads are completed.

S203, assigning available resources from the first target node to the first compute node to compose the first compute node based on node composition information in response to the first compute node being in a composable state.

S204, storing the node composition information in the configuration manager in response to the first compute node being in a non-composable state.

After the configuration manager selects the compute node for composition, the configuration manager may further determine whether the selected compute node is in a state that is ready for composing. In some embodiments, the selected compute node may be in a composable state which is ready for composing. Examples of a composable state of a compute node may include, but is not limited to, when the selected compute node is powered on and its operating system has been booted, or when the available processing capacity of the computing resources at the selected compute node exceeds a certain threshold such that the available processing capacity is sufficient to process a new workload without affecting the state of the currently assigned workloads. When the first compute node is in the composable state, the configuration manager may attach the available resources from the first target node to the first compute node based on the node composition information to compose the first compute node to complete a new workload.

In some embodiments, the selected compute node may be in a non-composable state, which is not ready for composing. Examples of a non-composable state of a compute node may include, but is not limited to, when the compute node is not powered on, or when the available processing capacity of the computing resources at the selected compute node is under a certain threshold such that the available processing capacity is insufficient to process a new workload without affecting the state of the currently assigned workloads. When the first compute node is in the non-composable state, the configuration manager may store the node composition information and perform S202 in a predetermined time period or until a trigger event is satisfied. When it is determined that the first compute node is in a composable state, such as when the compute node is powered on or when the available processing capacity of the computing resources at the first compute node is sufficient to process the new workload, the configuration manager may send the node composition information to the first compute node.

In some embodiments, the node composition information may include, but is not limited to, one or more of the type of resources, amount of resources, or expected working duration of resources to complete specific workloads. For example, the node composition information may specify that 2 storage devices and 3 networking resources are needed for 30 minutes to complete a specific workload. As such, the configuration manager can track the usage of the resources, thereby improving the resource planning of the overall computing system.

In some embodiments, S202 may be repetitively performed in a predetermined time period, such as 30 seconds, 1 minute, or 5 minutes. In addition, to further reduce the delay in composing the first compute node, the first compute node may be configured to detect a trigger event, and S202 may be performed when the trigger event occurs. The trigger event may include, but is not limited to, the configuration manager receiving an alert from the first compute node indicating the available processing capacity of the first compute node has exceeded a certain threshold, an alerting indicating the amount of time to complete the currently assigned workload is below a time threshold, or an alert indicating that the first compute node has completed the currently assigned workloads. More specifically, the duration of the predetermined time period or the trigger event can be set based on actual needs, which is not limited in the present disclosure.

By using the workload management method described above, the configuration manager may select a first compute node and a first target node from a resource pool for composition, determine the first compute node state, assign available resources from the first target node to the first compute node based on node composition information in response to the first compute node being in a composable state, and store the node composition information in the configuration manager in response to the first compute node being in a non-composable state. Further, when the first compute node switches from the non-composable state to the composable state, the configuration manager can assign the available resources from the first target node to the first compute node based on the node composition information without delay. As such, the efficiency in composing a compute node can be improved by reducing the delay in composing the selected compute node.

In some embodiments, a compute node and/or a target node may be oversubscribed in the composing process. An oversubscribed compute node and/or target node can affect the overall performance of the computing system, as such, an embodiment of the present disclosure provides another workload management method which may be used to determine and manage the health state of the composed compute node and/or target node.

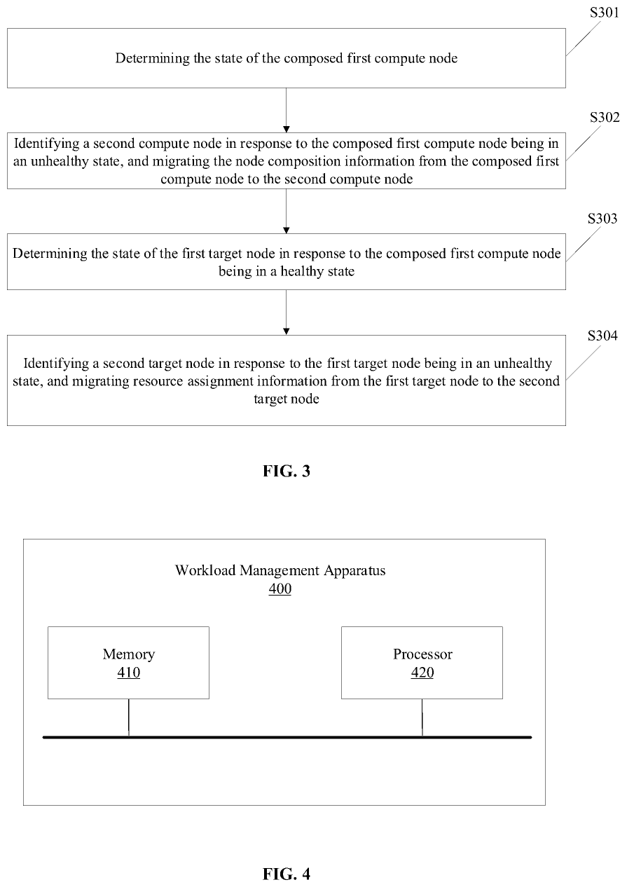

FIG. 3 is a flowchart of another workload management method according to an embodiment of the present disclosure. The workload management method will be described in detail below.

S301, determining the state of the composed first compute node.

After the shared resources are attached to the first compute node, it may be necessary to determine the state of the first compute node to ensure that the composed first compute node is not in an unhealthy state due to the process of composing. For example, an unhealthy state may include, but is not limited to, when the composed compute node is oversubscribed while the compute node is being composed. More specifically, the compute node may be oversubscribed when the compute node takes on additional processing tasks exceeding its processing bandwidth, which can affect the overall performance of the computing system.

S302, identifying a second compute node in response to the composed first compute node being in an unhealthy state, and migrating the node composition information from the composed first compute node to the second compute node.

In some embodiments, after determining that the composed first compute node is in an unhealthy state, the configuration manager can identify a second compute node that is in a composable state (e.g., when the selected compute node is powered on and its operating system has been booted, or when the available processing capacity of the computing resources at the selected compute node exceeds a certain threshold such that the available processing capacity is sufficient to process a new workload without affecting the state of the currently assigned workloads), and migrate the node composition information from the composed first compute node to the second compute node. For the method of selecting a compute node in the composable state and assigning available resources to the selected compute node, reference made be made to the description of S201 to S204 above, which will not be repeated herein again.

More specifically, migrating the node composition information from the composed first compute node to the second compute node may include releasing the resources from the first target node into the resource pool, and assigning the resources to the second compute node based on the node composition information. After the configuration manager identifies the second compute node, the resources assigned to the first compute node from the first target node may be released from the first compute node. At this point, if the second compute node is in a composable state, the released resources may be directly assigned to the second compute node based on the node composition information. Alternatively, if the second compute node is in a non-composable state, the released resources may be first released into the resource pool. When the second compute node switches from the non-composable state to the composable state, the resources may be assigned to the second compute node based on the node composition information.

S303, determining the state of the first target node in response to the composed first compute node being in a healthy state.

In some embodiments, after the shared resources are attached to the selected compute node, it may be necessary to determine the state of the target node to ensure that the target node is not in an unhealthy state due to the process of composing. For example, an unhealthy state may include, but is not limited, when the target node whose resources are being assigned to the composed compute node is oversubscribed. More specifically, excessive resources may be taken away from the target node such that the target node may not have sufficient resources to complete the processing tasks assigned to the target node.

S304, identifying a second target node in response to the first target node being in an unhealthy state, and migrating resource assignment information from the first target node to the second target node.

In some embodiments, after determining that the first target node is in an unhealthy state (e.g., a state in which the first target node is oversubscribed), the configuration manager can identify a second target node that is in a healthy state (e.g., a state in which the second target node is not oversubscribed), and migrate the resource assignment information from the first target node to the second target node.

More specifically, migrating the resource assignment information from the first target node to the second target node may include detaching the resources of the first target node from the composed first compute node, reassigning the resources to the first target node, and attaching the resources from the second target node to the composed first compute node based on the resource assignment information. After the configuration manager identifies the second target node, the resources of the first target node may be detached from the composed first compute node and reassigned (that is, reattached) to the first target node, thereby returning the first target node to the healthy state from the unhealthy state. Subsequently, the resources from the second target node may be assigned (that is, attached) to the composed first compute node based on the resource assignment information. As such, the composed first compute node may continue to process the assigned workload using the resources from the second target node.

It should be noted that even though the processes of the workload management method of the present embodiment are described in a specific order, in some alternative implementations, these processes may be implemented in different orders. For example, determining the state of the target node may be performed before determining the state of the composed first compute node. In another example, determining the state of the target node and determining the state of the target node may be performed at the same time. The present disclosure does not limit the order of the processes of the workload management method of the present embodiment, and those skilled in the art may implement these processes based on the actual needs.

In some embodiments, in response to the first target node being in a healthy state, the configuration manager can repetitively performed S301 to S304 in a predetermined time period to ensure the composed compute node and/or the target node is not oversubscribed while the composed compute node is processing the assigned workloads. The predetermined time period may be, for example, 30 seconds, 1 minute, or 5 minutes. More specifically, the duration of the predetermined time period can be set based on actual needs, which is not limited in the present disclosure.

By using the workload management method described above, the configuration manager may determine the state of the composed first compute node, identify a second compute node in response to the composed first compute node being in an unhealthy state, and migrate the node composition information from the composed first compute node to the second compute node. Further, the configuration manager may determine the state of the target node in response to the composed first compute node being in a healthy state, identify a second target node in response to the first target node being in an unhealthy state, and migrate resource assignment information from the first target node to the second target node. In addition, in response to the first target node being in a healthy state, the configuration manager may perform the foregoing processes in a predetermined amount of time. As such, the health state of the composed compute node and the target node can be ensured, and the overall performance of the computing system can be improved.

FIG. 4 is a structural diagram of a workload management apparatus according to an embodiment of the present disclosure. The workload management apparatus 400 is configured to perform a method consistent with the present disclosure, such as one of the example methods described in this disclosure. As shown in FIG. 4, the workload management apparatus 1300 includes a memory 410 storing a computer program and a processor 420 configured to execute the computer program to perform part or all of a method consistent with the present disclosure, such as one of the example methods described in this disclosure.

The memory 410 can include a computer readable storage medium, which can include at least one of a static random access memory (SRAM), a dynamic random access memory (DRAM), an erasable programmable read only memory (EPROM), an electrically erasable programmable read-only memory (EEPROM), or a flash memory such as a USB memory.

The processor 420 may include a general-purpose microprocessor, an instruction set processor, and/or a related chipset and/or a special purpose microprocessor (e.g., an application specific integrated circuit (ASIC)), and the like. Processor 420 may also include an onboard memory for caching purposes. Alternatively, the processor 420 may be a single processing unit or a plurality of processing units for performing different acts of a method flow according to certain embodiments of the present disclosure.

In some embodiments, the processor 420 may be configured to execute the computer program stored in the memory 410 to select a first compute node and a first target node from a resource pool for composition, determine the first compute node state, assign available resources from the first target node to the first compute node to compose the first compute node based on node composition information in response to the first compute node being in a composable state, and store the node composition information in the configuration manager in response to the first compute node being in a non-composable state.

In some embodiments, when the first compute node switches from the non-composable state to the composable state, the computer program stored in the memory 410 may cause the processor 420 to assign the available resources from the first target node to the first compute node based on the node composition information without delay. As such, the efficiency in composing a compute node can be improved by reducing the delay in composing the selected compute node.

The resource pool may include a plurality of compute nodes, and the processor 420 can select a first compute node for composition based on the composition request. Subsequently, available resources at the first target node may be assigned to the first compute node to complete specific workloads. For example, if a specific workload needs 2 storage devices and 3 networking resources to complete, the processor 420 can issue a composition request including this need to the first compute node that can handle the specific workload, identify the first target node having 2 storage devices and 3 networking resources to share, and assign the 2 storage devices and 3 networking resources to the first compute node to complete the specific workload.

After the processor 420 selects the compute node for composition, the processor 420 may further determine whether the selected compute node is in a state that is ready for composing.

In some embodiments, the state of the first compute node may be determined by the processor 420 actively querying the state of the first compute node. For example, when a compute node is selected as the first compute node, the processor 420 may send a query to the first compute node to check on the state of the first compute node. In response to receiving the query from the processor 420, the first compute node may report the operating state of the first compute node to the processor 420.

In some embodiments, the state of the first compute node may be determined by the first compute node actively reporting its state to the processor 420 in response to satisfying a condition. The condition may include, but is not limited to, when the workloads currently assigned to the first compute node are completed, or when a set portion of the workloads currently assigned to the first compute node are completed. For example, the first compute node may report its operating state to the processor 420 when 90% of the currently assigned workloads are completed.

In some embodiments, the selected compute node may be in a composable state which is ready for composing. Examples of a composable state of a compute node may include, but is not limited to, when the selected compute node is powered on and its operating system has been booted, or when the available processing capacity of the computing resources at the selected compute node exceeds a certain threshold such that the available processing capacity is sufficient to process a new workload without affecting the state of the currently assigned workloads. When the first compute node is in the composable state, the processor 420 may attach the available resources from the first target node to the first compute node based on the node composition information to compose the first compute node to complete a new workload.

In some embodiments, the selected compute node may be in a non-composable state, which is not ready for composing. Examples of a non-composable state of a compute node may include, but is not limited to, when the compute node is not powered on, or when the available processing capacity of the computing resources at the selected compute node is under a certain threshold such that the available processing capacity is insufficient to process a new workload without affecting the state of the currently assigned workloads. When the first compute node is in the non-composable state, the processor 420 may store the node composition information and determine the state of the first compute node in a predetermined time period or until a trigger event is satisfied. When it is determined that the first compute node is in a composable state, such as when the compute node is powered on or when the available processing capacity of the computing resources at the first compute node is sufficient to process the new workload, the processor 420 may send the node composition information to the first compute node.

In some embodiments, the node composition information may include, but is not limited to, one or more of the type of resources, amount of resources, or expected working duration of resources to complete specific workloads. For example, the node composition information may specify that 2 storage devices and 3 networking resources are needed for 30 minutes to complete a specific workload. As such, the processor 420 can track the usage of the resources, thereby improving the resource planning of the overall computing system.

In some embodiments, the processor 420 may repetitively determine the state of the first compute node in a predetermined time period, such as 30 seconds, 1 minute, or 5 minutes. In addition, to further reduce the delay in composing the first compute node, the first compute node may be configured to detect a trigger event, and the processor 420 may determine the state of the first compute node when the trigger event occurs. The trigger event may include, but is not limited to, the processor 420 receiving an alert from the first compute node indicating the available processing capacity of the first compute node has exceeded a certain threshold, an alerting indicating the amount of time to complete the currently assigned workload is below a time threshold, or an alert indicating that the first compute node has completed the currently assigned workloads. More specifically, the duration of the predetermined time period or the trigger event can be set based on actual needs, which is not limited in the present disclosure.

After the shared resources are attached to the first compute node, it may be necessary to determine the state of the first compute node to ensure that the composed first compute node is not in an unhealthy state due to the process of composing. For example, an unhealthy state may include, but is not limited to, when the composed compute node is oversubscribed while the compute node is being composed. More specifically, the compute node may be oversubscribed when the compute node takes on additional processing tasks exceeding its processing bandwidth, which can affect the overall performance of the computing system.

As such, the processor 420 may be further configured to execute the computer program stored in the memory 410 to determine the state of the composed first compute node, identify a second compute node in response to the composed first compute node being in an unhealthy state, and migrate the node composition information from the composed first compute node to the second compute node.

In some embodiments, after determining that the composed first compute node is in an unhealthy state, the processor 420 can identify a second compute node that is in a composable state (e.g., when the selected compute node is powered on and its operating system has been booted, or when the available processing capacity of the computing resources at the selected compute node exceeds a certain threshold such that the available processing capacity is sufficient to process a new workload without affecting the state of the currently assigned workloads), and migrate the node composition information from the composed first compute node to the second compute node. For the method of selecting a compute node in the composable state and assigning available resources to the selected compute node, reference made be made to the description of S201 to S204 above, which will not be repeated herein again.

More specifically, migrating the node composition information from the composed first compute node to the second compute node may include releasing the resources from the first target node into the resource pool, and assigning the resources to the second compute node based on the node composition information. After the processor 420 identifies the second compute node, the resources assigned to the first compute node from the first target node may be released from the first compute node. At this point, if the second compute node is in a composable state, the released resources may be directly assigned to the second compute node based on the node composition information. Alternatively, if the second compute node is in a non-composable state, the released resources may be first released into the resource pool. When the second compute node switches from the non-composable state to the composable state, the resources may be assigned to the second compute node based on the node composition information.

In some embodiments, after the shared resources are attached to the selected compute node, it may be necessary to determine the state of the target node to ensure that the target node is not in an unhealthy state due to the process of composing. For example, an unhealthy state may include, but is not limited, when the target node whose resources are being assigned to the composed compute node is oversubscribed. More specifically, excessive resources may be taken away from the target node such that the target node may not have sufficient resources to complete the processing tasks assigned to the target node

As such, the processor 420 may be further configured to execute the computer program stored in the memory 410 to determine the state of the first target node in response to the composed first compute node being in a healthy state, identify a second target node in response to the first target node being in an unhealthy state, and migrate resource assignment information from the first target node to the second target node. In addition, in response to the first target node being in a healthy state, processor 420 may be further configured to perform the foregoing processes in a predetermined amount of time. As such, the health state of the composed compute node and the target node can be ensured, and the overall performance of the computing system can be improved.

As will be appreciated by one skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

According to the embodiments of the present disclosure, the processor 420 may interact with the computer readable storage medium to execute the method or any other variation thereof according to the embodiments of the present disclosure.

It will be appreciated by those skilled in the art that the variations and/or combinations of the various embodiments of the present disclosure and/or the claims may be made, even if such variations or combinations are not explicitly described in the present disclosure. In particular, various combinations of the features described in the various embodiments and/or claims of the present disclosure can be made without departing from the spirit and scope of the disclosure. All such combinations fall within the scope of the disclosure.

Although the present disclosure has been shown and described with respect to the specific exemplary embodiments, it will be understood by those skilled in the art that various changes in form and detail can be made to the present disclosure. Therefore, the scope of the present disclosure should not be limited to the forgoing described embodiments, but should be determined not only by the appended claims but also by the equivalents of the appended claims.

What is claimed is:

1. A workload management method, comprising:
selecting a first compute node and a first target node from a resource pool for composition;
determining the first compute node state;
assigning available resources from the first target node to the first compute node to compose the first compute node in response to the first compute node being in a composable state based on node composition information; and
storing the node composition information in a configuration manager in response to the first compute node being in a non-composable state.

2. The method of claim 1, wherein the composable state includes:
the first compute node being powered on and an operating system of the first compute node is booted, or
an available processing capacity of the first compute exceeding a threshold.

3. The method of claim 1, wherein the non-composable state includes:
the first compute node being powered off, or
the available processing capacity of the first compute lower than the threshold.

4. The method of claim 1, wherein determining the first compute node state includes:
the configuration manager querying an operating state of the first compute node, or the first compute node reporting the operating state in response to the first compute node meeting a condition.

5. The method of claim 4, wherein the condition includes:
the first compute node completing a set portion of currently assigned workloads.

6. The method of claim 1, wherein determining the first compute node state further includes:
determining the first compute node state in a time period, or in response to the first compute node detecting a trigger event.

7. The method of claim 1, further comprising:
determining a state of the composed first compute node; and
identifying a second compute node in response to the composed first compute node being in an unhealthy state, and migrating the node composition information from the composed first compute node to the second compute node.

8. The method of claim 7, further comprising:
determining a state of the first target node in response to the composed first compute node being in a healthy state; and
identifying a second target node in response to the first target node being in an unhealthy state, and migrating resource assignment information from the first target node to the second target node.

9. The method of claim 7, wherein the unhealthy state of the composed first compute node includes the composed first compute node being oversubscribed.

10. The method of claim 7, wherein the unhealthy state of the first target node includes the first target node being oversubscribed.

11. A workload management apparatus, comprising:
a processor; and
a memory storing one or more sets of instruction sets that, when executed by the processor, causes to the processor to
select a first compute node and a first target node from a resource pool for composition;
determine the first compute node state;
assign available resources from the first target node to the first compute node to compose the first compute node in response to the first compute node being in a composable state based on node composition information; and
store the node composition information in a configuration manager in response to the first compute node being in a non-composable state.

12. The apparatus of claim 11, wherein the composable state includes:
the first compute node being powered on and an operating system of the first compute node is booted, or
an available processing capacity of the first compute exceeding a threshold.

13. The apparatus of claim 11, wherein the non-composable state includes:
the first compute node being powered off, or
the available processing capacity of the first compute lower than the threshold.

14. The apparatus of claim 11, wherein determine the first compute node state includes:
the configuration manager querying an operating state of the first compute node, or the first compute node reporting the operating state in response to the first compute node meeting a condition.

15. The apparatus of claim 14, wherein the condition includes:
the first compute node completing a set portion of currently assigned workloads.

16. The apparatus of claim 11, wherein determine the first compute node state further includes:
determining the first compute node state in a time period, or in response to the first compute node detecting a trigger event.

17. The apparatus of claim 11, wherein the instruction sets further causes the processor to:
determine a state of the composed first compute node; and
identify a second compute node in response to the composed first compute node being in an unhealthy state, and migrate the node composition information from the composed first compute node to the second compute node.

18. The apparatus of claim 17, wherein the instruction sets further causes the processor to:
determine a state of the first target node in response to the composed first compute node being in a healthy state; and
identify a second target node in response to the first target node being in an unhealthy state, and migrate resource assignment information from the first target node to the second target node.

19. A computing system, comprising:
a resource pool including a plurality of compute nodes and target nodes; and
a configuration manager configured to compose a first compute node by
selecting the first compute node and a first target node from the resource pool;
determining the first compute node state;
assigning available resources from the first target node to the first compute node to compose the first compute node in response to the first compute node being in a composable state based on node composition information; and
storing the node composition information in response to the first compute node being in a non-composable state.

20. The computing system of claim 19, wherein the configuration manager composing the first compute node further includes:
determining a state of the composed first compute node;
identifying a second compute node in response to the composed first compute node being in an unhealthy state, and migrating the node composition information from the composed first compute node to the second compute node;
determining a state of the first target node in response to the composed first compute node being in a healthy state; and
identifying a second target node in response to the first target node being in an unhealthy state, and migrating resource assignment information from the first target node to the second target node.
